(19) United States
(12) Patent Application Publication
(10) Pub. No.: US 2017/0036173 A1
(43) Pub. Date: Feb. 9, 2017

(54) MEMBRANES AND METHOD FOR THE PRODUCTION THEREOF

(71) Applicant: LEIBNIZ-INSTITUT FUER POLYMERFORSCHUNG DRESDEN E.V, Dresden (DE)

(72) Inventors: Jochen MEIER-HAACK, Dresden (DE); Christian LANGNER, Dresden (DE)

(73) Assignee: LEIBNIZ-INSTITUT FUER POLYMERFORSCHUNG DRESDEN E.V ., Dresden (DE)

(21) Appl. No.: 15/225,052

(22) Filed: Aug. 1, 2016

(30) Foreign Application Priority Data
Aug. 5, 2015 (DE) 102015214896.3

(51) Int. Cl. B01D 69/12; C09D 177/00; C09D 171/02; B01D 61/02; B01D 61/14; B01D 71/26; B01D 71/68; B01D 71/42; B01D 71/34; B01D 71/48; B01D 71/56; B01D 71/54; C09D 181/06; B01D 67/00

(52) U.S. Cl. CPC B01D 69/125; C09D 181/06; C09D 177/00; C09D 171/02; B01D 61/025; B01D 61/145; B01D 67/0002; B01D 67/0095; B01D 71/68; B01D 71/42; B01D 71/34; B01D 71/48; B01D 71/56; B01D 71/54; B01D 71/26; B01D 2325/36; B01D 2323/08

(57) ABSTRACT

The invention concerns the field of polymer chemistry and relates to membranes, such as those used as membranes for the preparation of aqueous solutions by means of reverse osmosis or microfiltration, ultrafiltration or nanofiltration, for example.

The object of the present invention is the specification of membranes that exhibit a reduced fouling tendency with equally suitable or improved filtration properties, as well as the specification of a simple and cost-effective method for the production thereof.

The object is attained with membranes comprising a substrate on which a porous supporting layer is arranged, on which supporting layer a separation-active layer is arranged, and on which separation-active layer a cover layer is also arranged, wherein the material of the separation-active layer comprises functional groups which primarily have carbon-carbon triple bonds and/or carbon-nitrogen triple bonds, and wherein the material of the cover layer has functional groups which are primarily at least azide groups, and the functional groups having at least carbon-carbon triple bonds and/or carbon-nitrogen triple bonds are chemically coupled covalently with the azide groups.

### CROSS-REFERENCE TO RELATED APPLICATIONS

This application claims priority under 35 U.S.C. §119(a) of German Application No. DE 10 2015 214 896.3 filed Aug. 5, 2015, the disclosure of which is expressly incorporated by reference herein in its entirety.

The invention concerns the field of polymer chemistry and relates to membranes, such as those used as membranes for the preparation of aqueous solutions by means of reverse osmosis or microfiltration, ultrafiltration or nanofiltration, for example as low-fouling membranes, and to a method for the production thereof.

Despite research activities across the globe, fouling continues to be a significant problem in membrane filtration. In addition to the pre-purification of the feed, the design, operating conditions and purification of the membranes, the properties of the membrane surface itself constitute an essential aspect for the fouling tendency of membranes (G. M. Giese,: J. Polym. Sci. Part B, Polym. Phys. 48 (2010) 1685).

Numerous approaches to reducing membrane fouling by modifying the membrane surface are known. In most cases, the hydrophilization of the membrane surface is sought.

D. Rana and T. Matsuura: Chem. Rev. 110 (2010) 2448 provide an overview of various surface modification methods that are intended to achieve reduced fouling in membranes.

According to S. Azari and L. Zou: J. Membr. Sci. 401-402 (2012) 68, nanofiltration membranes are known which, by being coated with 3-(3,4-dihydroxyphenyl)-L-alanine (L-DOPA), exhibit reduced fouling during the filtration of protein solutions and surfactant solutions.

Kramer et al.: Colloids and Surfaces A: 137 (1998) 45 report that polyelectrolyte complexes are not stable when high ionic strengths are present, as a consequence of which said complexes are not suitable for the modification of reverse osmosis membranes.

From J. Meier-Haack and M. Müller: Macromol. Symp. 188 (2002) 91, the modification of membrane surfaces with polyelectrolytes and polyelectrolyte complexes is known.

Q. An et al.: J. Membr. Sci. 367 (2011)158 discloses the modification of thin film composite polyamide (TFC PA) nanofiltration membranes by means of polymerization of polyvinyl alcohol into the polyamide layer.

According to Z. Yong et al.: J. Membr. Sci. 270 (2006) 162, TFC PA reverse osmosis membranes are known which contain sulfonated monomer units in the polyamide layer.

According to Y.-C. Chiang et al.: J. Membr. 389 (2012) 76, a TFC PA nanofiltration membrane is known which has acquired a zwitterionic surface through chemical modification with 1.) iodopropanoic acid and 2.) methyl iodide.

From V. Feger et al.: J. Membr. Sci. 209 (2002) 283, TFE PA reverse osmosis membranes are known which are modified by means of redox-initiated grafting of acrylic acid.

Q. Cheng et al.: J. Membr. Sci. 447 (2013) 236 report on the surface modification of TFC PA reverse osmosis membranes by means of radical grafting of N-isopropylacrylamide and acrylic acid.

G. Kang et al.: Desalination 275 (2011) 252-259 describe a method with which amine-terminated polyethylene glycols (Jeffamine®) are grafted onto the surface of commercial reverse osmosis (RO) membranes using carbodiimide. For the coupling of the amine-terminated polyethylene glycols, excess carboxylic acid groups located on the surface are used. The membranes show an improved fouling performance during the filtration of milk or of cationic surfactants. However, the grafting reaction takes place too slowly for industrial applications.

Additionally, the carbodiimide-catalyzed grafting of imidazolidinyl urea onto TFC PA reverse osmosis membranes in order to improve the chlorine stability and reduce the fouling tendency is known from J. Xu et al.: J. Membr. Sci. 435 (2013) 80.

The use of excess acid chloride groups after the interfacial polymerization for producing TFC PA membranes for the purpose of surface modification is known from Kang et al.: Polymer 48 (2007) 1165; D. Nikolaeva et al.: J. Membr. Sci. 476 (2015) 264; L. Zou et al.: Sep. Pur. Technol. 72 (2010) 256.

From U.S. Pat. No. 8,505,743 B2, a method is known in which the coating of an RO membrane with poly(amide amine) (PAMAM) dendrimers that possibly contain silver nanoparticles is initially performed, onto which coating polyethylene glycols (PEG) are grafted in a subsequent step. The coupling of the PEGs occurs via the amino groups of the PAMAM layer through the use of N-PEG succinimide or PEG glycidol. The coating is not fixed to the membrane surface.

According to US 2013/0102740 A1, polymer materials containing ethynyl groups are known for ion-exchange membranes. The ethynyl groups are used for thermally initiated crosslinking reactions.

Ion-exchange membranes containing ethynyl groups are also known from Kim et al.: J. Membr. Sci. 378 (2011) 512, wherein the ethynyl groups are used to thermally crosslink the membrane material.

According to Xie et al.: J. Appl. Polym. Sci. 132 (2015) 41549, the modification of polysulfone, and of ultrafiltration membranes produced therefrom, with propargyl alcohol by means of a copper-catalyzed 1,3-dipolar cycloaddition is known. The polymer is first chloromethylated, after which an azide functionality is introduced by conversion with sodium azide. The azide group is used to bind propargyl alcohol by means of a 1,3-dipolar cycloaddition. The entire polymer material is thus functionalized with hydrophilic groups (hydroxyl groups) before the membrane production.

According to Dimitrov et al.: J. Membr. Sci. 450 (2014) 362 and Macromol. Rapid Commun. 33 (2012) 1368, the functionalization of polysulfone with phosphonated poly(pentafluorostyrene) is known. The azide group is obtained through a lithiation of the polysulfone and conversion with chloromethylbenzoyl chloride and subsequent exchange reaction with sodium azide at the chloromethyl group. The grafting of poly(pentafluorostyrene) occurs by means of a copper-catalyzed 1,3-dipolar cycloaddition with ethynyl-terminated poly(pentafluorostyrene).

Aimi et al.: Polymer Preprints 49 (2008) 343 describes the synthesis of poly(vinylacetylene) block copolymers as a precursor for structured nanocarbon materials.

The known solutions have the disadvantage that the membranes still exhibit too high of a fouling tendency and/or that the filtration properties, such as permeability and rejection, are poorer compared to unmodified membranes.

The object of the present invention is the specification of membranes that exhibit a reduced fouling tendency with equally suitable or improved filtration properties, as well as the specification of a simple and cost-effective method for the production thereof.

The object is attained by the invention disclosed in the claims. Advantageous embodiments are the subject matter of the dependent claims.

The membranes according to the invention comprise at least one substrate on which a porous supporting layer is arranged, on which supporting layer at least one separation-active layer is arranged, and on which separation-active layer at least one cover layer is also arranged, wherein the separation-active layer is composed of polymers applied by means of interfacial polymerization or of the material of the porous supporting layer and is an integral part of the porous supporting layer, and wherein the material of the separation-active layer comprises functional groups which primarily have carbon-carbon triple bonds and/or carbon-nitrogen triple bonds, and wherein the material of the cover layer has functional groups which are primarily at least azide groups, and the functional groups with at least carbon-carbon triple bonds and/or carbon-nitrogen triple bonds of the material of the separation-active layer are chemically coupled covalently with the azide groups of the material of the cover layer in the region of contact between the separation-active layer and the cover layer.

Advantageously, the substrate is a textile fabric, advantageously a fleece.

Also advantageously, the material of the porous supporting layer and/or the separation-active layer is polysulfone or polyethersulfone or polyacrylonitrile or polyvinylidene fluoride or polyester.

Further advantageously, the material of the separation-active layer is composed of polymers applied by means of interfacial polymerization, such as advantageously polyamide, polyester, polyurethane, polysulfonamide and/or polyurea.

And also advantageously, the cover layer is composed of a hydrophilic multifunctional material that is water soluble and/or alcohol soluble and/or soluble in a water/alcohol mix and is advantageously highly branched.

It is also advantageous if the cover layer is composed of polyethyleneimine and/or polypropylene and/or poly(amide amine) and/or polyamine and/or polyetherol and/or polyol and/or polysaccharide and/or chitosan and/or polyalkyloxazoline.

It is further advantageous if the concentration of the functional groups of the material of the separation-active layer is between 1% and 10%, wherein at least 75% to 100% of these functional groups are functional groups with at least carbon-carbon triple bonds and/or carbon-nitrogen triple bonds; it is more advantageous if the concentration of the functional groups with at least carbon-carbon triple bonds and/or carbon-nitrogen triple bonds in the material of the separation-active layer is 75% to 100% of the functional groups.

It is likewise advantageous if the functional groups having at least carbon-carbon triple bonds and/or carbon-nitrogen triple bonds are ethynyl groups or nitrile groups.

And it is also advantageous if each molecule of the material forming the cover layer contains at least one azide group.

In the method according to the invention for producing membranes, at least one porous supporting layer is applied to a substrate, onto which supporting layer at least one separation-active layer is subsequently applied which is an integral part of the porous supporting layer, and onto which separation-active layer at least one cover layer is then also directly applied, wherein a material having functional groups is used as material of the separation-active layer, or functional groups are polymerized into the material of the separation-active layer before the application of the cover layer, wherein the functional groups of the material of the separation-active layer comprise primarily carbon-carbon triple bonds and/or carbon-nitrogen triple bonds, and wherein the material of the cover layer comprises functional groups which are primarily at least azide groups, and the functional groups having at least carbon-carbon triple bonds and/or carbon-nitrogen triple bonds of the material of the separation-active layer are chemically coupled covalently with the azide groups of the material of the cover layer in the region of contact between the separation-active layer and the cover layer via a 1,3-dipolar cycloaddition reaction during and/or after the application of the cover layer.

Advantageously, polysulfone or polyethersulfone or polyacrylonitrile or polyvinylidene fluoride or polyester is used as material of the porous supporting layer and/or the separation-active layer.

Also advantageously, the separation-active layer is produced by means of interfacial polymerization.

Further advantageously, the functional groups are introduced into the material during the production of the material of the separation-active layer by the use of monomers containing functional groups.

And also advantageously, the cover layer is applied to the separation-active layer in the form of an aqueous solution and/or an alcoholic solution and/or a solution in a water/alcohol mix using a spraying method or a drawdown method or a dipping method, advantageously immediately after the interfacial polymerization of the separation-active layer.

It is also advantageous if a material having a concentration of the functional groups of between 1% and 10% is used as material of the separation-active layer, wherein at least 75% to 100% of these functional groups are functional groups with at least carbon-carbon triple bonds and/or carbon-nitrogen triple bonds, wherein more advantageously a material in which the concentration of the functional groups having at least carbon-carbon triple bonds and/or carbon-nitrogen triple bonds is 75% to 100% of the functional groups is used as material of the separation-active layer, and/or wherein likewise advantageously a material having functional groups with at least carbon-carbon triple bonds and/or carbon-nitrogen triple bonds is used as material of the separation-active layer, wherein the function groups are ethynyl groups or nitrile groups.

It is also advantageous if an aqueous solution and/or an alcoholic solution and/or a solution in a water/alcohol mix of the cover layer material is used as material of the cover layer, in which each molecule of the material forming the cover layer contains at least one azide group.

It is likewise advantageous if the chemically covalent coupling of the functional groups having at least carbon-carbon triple bonds and/or carbon-nitrogen triple bonds of the material of the separation-active layer with the azide groups of the material of the cover layer is achieved via a copper-catalyzed 1,3-dipolar cycloaddition reaction.

It is further advantageous if a catalyst, advantageously a copper(I) salt, is applied to the separation-active layer with the material of the cover layer.

The use specified by the invention of the membranes according to the invention that have been produced according to the invention occurs for the preparation of aqueous solutions by means of reverse osmosis or microfiltration or nanofiltration or ultrafiltration.

With the solution according to the invention, it is possible for the first time to specify of membranes that exhibit a reduced fouling tendency with equally suitable or improved filtration properties, as well as a simple and cost-effective method for the production thereof.

This is achieved with membranes that basically comprise a substrate, a porous supporting layer, a separation-active layer and a cover layer which are essentially arranged on top of one another in this order. It is thereby essential to the invention that the cover layer is coupled to the separation-active layer in a chemically covalent manner. This coupling occurs via functional groups of the material of the separation-active layer, which groups comprise primarily carbon-carbon triple bonds and/or carbon-nitrogen triple bonds, and via functional groups of the material of the cover layer, which are primarily at least azide groups. These functional groups are coupled via a 1,3-dipolar cycloaddition reaction.

The substrate is advantageously a textile fabric, such as a fleece, onto which a porous supporting layer can be applied by a spraying or drawdown or dipping. The porous supporting layer can thereby be composed of polysulfone or polyethersulfone or polyacrylonitrile or polyvinylidene fluoride or polyester.

The separation-active layer located on the porous supporting layer can, in the case of ultrafiltration membranes and possibly also in the case of microfiltration membranes, be composed of the same material as the porous supporting layer and be an integral part of the porous supporting layer, or it can advantageously be produced on the porous supporting layer by means of interfacial polymerization. In this case, the separation-active layer can be composed of polyamide, polyester, polysulfonamide, polyurethane and/or polyurea.

According to the invention, it is necessary that the material of the separation-active layer contain functional groups that must comprise primarily carbon-carbon triple bonds and/or carbon-nitrogen triple bonds. During the production of the material of the separation-active layer, the functional groups of the separation-active layer are introduced into the material by the use of monomers containing functional groups. For example, ethynyl hydroquinone, ethynyl resorcinol, propargyl hydroquinone, propargyl resorcinol, 2,4-diaminophenylethyne, 2,5-diaminophenylethyne, 3,5-diaminophenylethyne, dimercaptophenylethyne, ethynylaniline, 2,6-difluorobenzonitrile, 2,4-difluorobenzonitrile, acrylonitrile, vinylacetylene can be used as monomers containing functional groups.

The functional groups are thereby preferably present in the separation-active layer in a concentration between 1% and 10%, in a concentration up to 100% for the use of, for example, polyacrylonitrile as a material for the porous supporting layer and the separation-active layer, wherein at least 75% to 100% of these functional groups are functional groups having at least carbon-carbon triple bonds and/or carbon-nitrogen triple bonds. These functional groups of the separation-active layer, which are necessary according to the invention, are advantageously ethynyl groups or nitrile groups.

Following the production of the separation-active layer containing functional groups, in which the functional groups are primarily carbon-carbon triple bonds and/or carbon-nitrogen triple bonds, the cover layer can be applied.

The cover layer is thereby advantageously composed of a hydrophilic multifunctional material that is water soluble and/or alcohol soluble and/or soluble in a water/alcohol mix and advantageously highly branched, such as polyethyleneimine and/or polypropylene and/or poly(amide amine) and/or polyamine and/or polyetherol and/or polyol and/or polysaccharide and/or chitosan and/or polyalkyloxazoline. This material of the cover layer can advantageously be applied to the separation-active layer using a spraying method or a drawdown method or a dipping method.

Here, it is also necessary according to the invention that the material of the cover layer comprise functional layers, wherein each molecule of the material forming the cover layer contains at least one azide group.

According to the invention, the functional groups having at least carbon-carbon triple bonds and/or carbon-nitrogen triple bonds of the material of the separation-active layer are chemically coupled covalently with the azide groups of the material of the cover layer in the region of contact between the separation-active layer and the cover layer via a 1,3-dipolar cycloaddition reaction during and/or after the application of the cover layer.

This 1,3-dipolar cycloaddition reaction is advantageously a catalyzed 1,3-dipolar cycloaddition reaction, more advantageously a copper-catalyzed 1,3-dipolar cycloaddition reaction. For a catalyzed 1,3-dipolar cycloaddition reaction, copper(I) salt can for example be applied to the separation-active material as a catalyst with the material of the cover layer.

As a result of this coupling, the linear and/or highly branched hydrophilic multifunctional polymers of the cover layer can be bonded to the polymers of the separation-active layer in a manner that is secure and stable over the long term.

With the solution according to the invention, functional groups having carbon-carbon triple bonds or carbon-nitrogen triple bonds, such as ethynyl groups or nitrile groups for example, are used for the first time for the coupling to azide groups via a 1,3-dipolar cycloaddition reaction in order to couple a cover layer to a separation-active layer of membranes in a chemically covalent manner.

In particular, the solution according to the invention differs from the prior art in that functional groups having carbon-carbon triple bonds or carbon-nitrogen triple bonds, such as ethynyl groups or nitrile groups for example, are present in the material of the separation-active layer in each case. The coupling with azide groups of the material forming the cover layer only occurs after the separation-active layer has been formed and if the groups are placed in the region of contact between the separation-active layer and the cover layer by the material of the cover layer. In contrast to the solutions from the prior art, this coupling also only takes place in the region of contact between the separation-active layer and the cover layer. The other functional groups present in the respective material of the separation-active layer and the cover layer do not enter into a coupling with one another, and at least the uncoupled functional groups of the cover layer are available for coupling with other functional groups.

This type of coupling between layers was not previously known for membranes.

As a result of the coupling according to the invention, another advantage of the solution specified by the invention is that water soluble polymers can also be used as cover layer materials.

In particular, the membranes specified by the invention and produced according to the invention can be used for the preparation of aqueous solutions by means of reverse osmosis or microfiltration or nanofiltration or ultrafiltration.

The membranes according to the invention exhibit a markedly increased hydrophilicity and thus show an essentially significantly reduced fouling tendency with no negative impact on the filtration properties, such as permeability and rejection, in comparison with unmodified membranes.

The invention is explained below in greater detail with the aid of several exemplary embodiments.

### COMPARATIVE EXAMPLE 1

### Production of an RO Membrane without a Cover Layer (MEM-1)

An ultrafiltration membrane (UF membrane) comprising a fleece as a substrate and a polyether sulfone located thereon as a porous supporting layer is impregnated with a solution of 20 g/L m-phenylenediamine in water. The excess solution is removed from the surface by a roller. The impregnated UF membrane is then coated with a solution of 1 g/L trimesoyl chloride (TMC) in a hexane/tetrahydrofuran (THF) mixture with 0.5% THF for the production of the separation-active layer. After a duration of 180 s, the excess solution is removed and the crude membrane is dried at room temperature for 30 s and at a temperature of 80 ° C. for 120 s. The reverse osmosis (RO) membrane produced in this manner is first washed with fully desalinated (FD) water for 2 h, then with 1 mM hydrochloric acid (pH=3) for 20 h, and then again with FD water for 2 h.

### EXAMPLE 2

### Production of an RO Membrane with a Coupled Cover Layer (MEM-2)

An ultrafiltration membrane (UF membrane) comprising a fleece as a substrate and a polyethersulfone located thereon as a porous supporting layer is impregnated with a solution of 20 g/L m-phenylenediamine and ethynylaniline in water/acetonitrile (3:1 mass/mass). The excess solution is removed from the surface by a roller. The impregnated UF membrane is then coated with a solution of 1 g/L TMC in a hexane/THF mixture with 0.5% THF for the production of the separation-active layer. After a duration of 180 s, the excess solution is removed and the crude membrane is dried at room temperature for 30 s and at a temperature of 80° C. for 120 s. The RO membrane produced in this manner is first washed with FD water for 2 h, then with 1 mM hydrochloric acid (pH=3) for 20 h, and then again with FD water for 2 h. The RO membrane is then coated with an aqueous solution of 1 g/L azide-terminated polyethylene glycol monoethyl ether for the production of the cover layer. Following the application of the aqueous solution, 1 mL of a solution of 0.8 g/L CuSO₄.5H₂O and 6.4 g/L sodium ascorbate is applied to the surface as a catalyst. After 4 hours, the excess solution is poured off from the membrane and the membrane is once again washed with FD water for 2 h, then with 1 mM hydrochloric acid (pH =3) for 20 h, and then again with FD water for 2 h.

### EXAMPLE 3

### Production of an RO Membrane with a Coupled Cover Layer (MEM-3)

A UF membrane comprising a fleece as a substrate and a polyethersulfone located thereon as a porous supporting layer is impregnated with a solution of 20 g/L m-phenylenediamine and ethynylaniline in water/acetonitrile (3:1 mass/mass). The excess solution is removed from the surface by a roller. The impregnated UF membrane is then coated with a solution of 1 g/L TMC in a hexane/THF mixture with 0.5% THF for the production of the separation-active layer. After a duration of 180 s, the excess solution is removed and the crude membrane is dried at room temperature for 30 s and at a temperature of 80° C. for 120 s. The RO membrane produced in this manner is first washed with FD water for 2 h, then with 1 mM hydrochloric acid (pH=3) for 20 h, and then again with FD water for 2 h. The RO membrane is then coated with an aqueous solution of 1 g/L azide-terminated polymethyloxazoline for the production of a cover layer. Following the application of the aqueous solution, 1 mL of a solution of 0.8 g/L CuSO₄.5H₂O and 6.4 g/L sodium ascorbate is applied to the surface as a catalyst. After 4 hours, the excess solution is poured off from the membrane and the membrane is once again washed with FD water for 2 h, then with 1 mM hydrochloric acid (pH=3) for 20 h, and then again with FD water for 2 h.

### COMPARATIVE EXAMPLE 4

### Production of an Ultrafiltration (UF) Membrane without a Cover Layer (MEM-4)

A polyester fleece as is fixed to a glass plate as a substrate and impregnated with a mixture of 60 vol % N-methylpyrrolidone (NMP) and 40 vol % water. After 1 min, the excess mixture is removed by a roller. A solution of polyethersulfone with 10 mol % ethynyl groups, which corresponds to a concentration of 200 g/L ethynyl groups in NMP, is applied to the impregnated polyester fleece at a thickness of 80 μm using a doctor blade and subsequently transferred to a water bath in order to precipitate out the polymer. After 30 min, the membrane is washed with FD water and stored in FD water at 4 ° C. The separation-active layer is an integral part of the porous supporting layer.

### EXAMPLE 5

### Production of a UF Membrane with a Cover Layer (MEM-5)

A polyester fleece as is fixed to a glass plate as a substrate and impregnated with a mixture of 60 vol % N-methylpyrrolidone (NMP) and 40 vol % water. After 1 min, the excess mixture is removed by a roller. A solution of polyethersulfone with 10 mol % ethynyl groups, which corresponds to a concentration of 200 g/L ethynyl groups in NMP, is applied to the impregnated polyester fleece at a thickness of 80 μm using a doctor blade and subsequently transferred to a water bath in order to precipitate out the polymer. After 30 min, the membrane is washed with FD water. The separation-active layer is an integral part of the porous supporting layer. The membrane is then placed in a frame and coated with an aqueous solution of 1 g/L azide-terminated polyethylene glycol monomethyl ether for the production of the cover layer. Following the application of the aqueous solution, 1 mL of a solution of 0.8 g/L CuSO₄.5H₂O and 6.4 g/L sodium ascorbate is applied to the surface as a catalyst. After 4 hours, the excess solution is poured off from the membrane and the membrane is washed with FD water for 2 h.

### Testing the RO Membranes MEM-1 through MEM-3

To analyze the performance of the membranes, the membranes were tested with an aqueous solution of 3.5 g/L sodium chloride at a pressure of 5 MPa and a flow rate of 90 kg/h. For this purpose permeability and salt rejection were measured.

To determine the fouling tendency of the membranes, the water flow was measured before and after the filtration of a protein solution with 1 g/L bovine serum albumin (BSA) at a pH of 7. Before the start of filtration, the membranes were conditioned at a pressure of 5 MPa for 16 h. The results are indicated in Table 1.

TABLE 1

| | | | Permeability |
|---|---|---|---|
| | | Salt | after protein |
| | Permeability | rejection | fouling |
| Membrane | (L/m²hbar) | (%) | (%) |
| MEM-1 | 0.71 | 98.2 | 90 |
| MEM-2 | 0.85 | 98.0 | 99 |
| MEM-3 | 0.88 | 98.5 | 99 |

### Testing the UF Membranes MEM-4 and MEM-5

To analyze the performance of the membranes, the membranes were tested with FD water to determine the permeability and with aqueous solutions of 1 g/L polyethylene glycol with molecular weights between 1000 and 100000 g/mol to determine the cut off (MWCO) (90% rejection of PEG 50000 g/mol) at a pressure of 0.3 MPa.

To determine the fouling tendency of the membranes, the water flow was measured before and after the filtration of a protein solution with 1 g/L bovine serum albumin (BSA) at a pH of 7. Before the start of filtration, the membranes were conditioned at a pressure of 0.4 MPa for 4 h. The results are indicated in Table 2.

TABLE 2

| | | | Permeability |
|---|---|---|---|
| | | | after protein |
| | Permeability | MWCO | fouling |
| Membrane | (L/m²hbar) | (g/mol) | (%) |
| MEM-4 | 235 | 50000 | 50 |
| MEM-5 | 199 | 50000 | 98 |

1. Membranes comprising at least one substrate on which a porous supporting layer is arranged, on which supporting layer at least one separation-active layer is arranged, and on which separation-active layer at least one cover layer is also arranged, wherein the separation-active layer is composed of polymers applied by means of interfacial polymerization or of the material of the porous supporting layer and is an integral part of the porous supporting layer, and wherein the material of the separation-active layer comprises functional groups which primarily have carbon-carbon triple bonds and/or carbon-nitrogen triple bonds, and wherein the material of the cover layer has functional groups which are primarily at least azide groups, and the functional groups having at least carbon-carbon triple bonds and/or carbon-nitrogen triple bonds of the material of the separation-active layer are chemically coupled covalently with the azide groups of the material of the cover layer in the region of contact between the separation-active layer and the cover layer.

2. The membranes according to claim 1 in which the substrate is a textile fabric, advantageously a fleece.

3. The membranes according to claim 1 in which the material of the porous supporting layer and/or the separation-active layer is polysulfone or polyethersulfone or polyacrylonitrile or polyvinylidene fluoride or polyester.

4. The membranes according to claim 1 in which the material of the separation-active layer is composed of polymers applied by means of interfacial polymerization, such as advantageously polyamide, polyester, polyurethane, polysulfonamide and/or polyurea.

5. The membranes according to claim 1 in which the cover layer is composed of a hydrophilic multifunctional material that is water soluble and/or alcohol soluble and/or soluble in a water/alcohol mix and is advantageously highly branched.

6. The membranes according to claim 1 in which the cover layer is composed of polyethyleneimine and/or polypropylene and/or poly(amide amine) and/or polyamine and/or polyetherol and/or polyol and/or polysaccharide and/or chitosan and/or polyalkyloxazoline.

7. The membranes according to claim 1 in which the concentration of the functional groups of the material of the separation-active layer is between 1% and 10%, wherein at least 75% to 100% of these functional groups are functional groups with at least carbon-carbon triple bonds and/or carbon-nitrogen triple bonds.

8. The membranes according to claim 7 in which the concentration of the functional groups having at least carbon-carbon triple bonds and/or carbon-nitrogen triple bonds in the material of the separation-active layer is 75% to 100% of the functional groups.

9. The membranes according to claim 1 in which the functional groups having at least carbon-carbon triple bonds and/or carbon-nitrogen triple bonds are ethynyl groups or nitrile groups.

10. The membranes according to claim 1 in which each molecule of the material forming the cover layer contains at least one azide group.

11. A method for producing membranes, in which at least one porous supporting layer is applied to a substrate, onto which supporting layer at least one separation-active layer is subsequently applied which is an integral part of the porous supporting layer, and onto which separation-active layer at least one cover layer is then also directly applied, wherein a material having functional groups is used as material of the separation-active layer, or functional groups are polymerized into the material of the separation-active layer before the application of the cover layer, wherein the functional groups of the material of the separation-active layer comprise primarily carbon-carbon triple bonds and/or carbon-nitrogen triple bonds, and wherein the material of the cover layer comprises functional groups which are primarily at least azide groups, and the functional groups having at least carbon-carbon triple bonds and/or carbon-nitrogen triple bonds of the material of the separation-active layer are chemically coupled covalently with the azide groups of the material of the cover layer in the region of contact between the separation-active layer and the cover layer via a 1,3-dipolar cycloaddition reaction during and/or after the application of the cover layer.

12. The method according to claim 11 in which polysulfone or polyethersulfone or polyacrylonitrile or polyvinylidene fluoride or polyester is used as material of the porous supporting layer and/or the separation-active layer.

13. The method according to claim 11 in which the separation-active layer is produced by means of interfacial polymerization.

14. The method according to claim 11 in which the functional groups are introduced into the material during the production of the material of the separation-active layer by the use of monomers containing functional groups.

15. The method according to claim 11 in which the cover layer is applied to the separation-active layer in the form of an aqueous solution and/or an alcoholic solution and/or a solution in a water/alcohol mix of the materials of the cover layer using a spraying method or a drawdown method or a dipping method, advantageously immediately following the interfacial polymerization of the separation-active layer.

16. The method according to claim 11 in which a material having a concentration of the functional groups of between 1% and 10% is used as material of the separation-active layer, wherein at least 75% to 100% of these functional groups are functional groups with at least carbon-carbon triple bonds and/or carbon-nitrogen triple bonds.

17. The method according to claim 16 in which, as material of the separation-active layer, a material is used in which the concentration of the functional groups with at least carbon-carbon triple bonds and/or carbon-nitrogen triple bonds is 75% to 100% of the functional groups.

18. The method according to claim 16 in which, as material of the separation-active layer, a material having functional groups with at least carbon-carbon triple bonds and/or carbon-nitrogen triple bonds is used, wherein the functional groups are ethynyl groups or nitrile groups.

19. The method according to claim 11 in which an aqueous solution and/or an alcoholic solution and/or a solution in a water/alcohol mix of the cover layer material is used as material of the cover layer, in which each molecule of the material forming the cover layer contains at least one azide group.

20. The method according to claim 11 in which the chemically covalent coupling of the functional groups having at least carbon-carbon triple bonds and/or carbon-nitrogen triple bonds of the material of the separation-active layer with the azide groups of the material of the cover layer is achieved via a copper-catalyzed 1,3-dipolar cycloaddition reaction.

21. The method according to claim 11 in which a catalyst, advantageously a copper(I) salt, is applied to the separation-active layer with the material of the cover layer.

22. A use of membranes according to claim 1 produced for the preparation of aqueous solutions by means of reverse osmosis or microfiltration or nanofiltration or ultrafiltration.
